(19) United States
(12) Patent Application Publication
(10) Pub. No.: US 2003/0049488 A1
(43) Pub. Date: Mar. 13, 2003

(54) Insulation containing separate layers of textile fibers and of rotary and/or flame attenuated fibers

(75) Inventors: Alain Yang, Bryn Mawr, PA (US); Gary Tripp, Corbin, KY (US); Wayne Shaw, Glen Mills, PA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: CERTAINTEED CORPORATION, Valley Forge, PA

(21) Appl. No.: 09/946,475

(22) Filed: Sep. 6, 2001

(51) Int. Cl. B29C 43/22

(52) U.S. Cl. 428/688; 264/555; 422/59; 428/361

(57) ABSTRACT

A fiber insulation product for use as, e.g., a ductliner, includes at least one textile fiber layer laminated with at least one rotary and/or flame attenuated fiber layer. The fiber laminate provides improved thermal and acoustic insulation and excellent strength, at a low production cost.

### BACKGROUND OF THE INVENTION

1. Field of the Invention

This invention relates to fiber insulation. More specifically, this invention relates to thermal and acoustic insulation containing at least one layer of textile fibers and at least one layer of rotary and/or flame attenuated glass fibers for use in, e.g., ductliner.

2. Description of the Background

Glass and polymer fiber mats positioned in the gap between two surfaces can be used to reduce the passage of heat and noise between the surfaces.

Heat passes between surfaces by conduction, convection and radiation. Because glass and polymer fibers are relatively low thermal conductivity materials, thermal conduction along the fibers is minimal. Because the fibers slow or stop the circulation of air, mats of the fibers reduce thermal convection. Because fiber mats shield surfaces from direct radiation emanating from other surfaces, the fiber mats reduce radiative heat transfer. By reducing the conduction, convection and radiation of heat between surfaces, fiber mats provide thermal insulation.

Sound passes between surfaces as wave-like pressure variations in air. Because fibers scatter sound waves and cause partial destructive interference of the waves, a fiber mat attenuates noise passing between surfaces and provides acoustic insulation.

Conventional fiber mats or webs used for thermal and acoustic insulation are made either primarily from textile fibers, or from rotary or flame attenuated fibers. Textile fibers, used in thermal and acoustic insulation are typically chopped into segments 2 to 15 cm long and have diameters of greater than 5 μm up to 16 μm. Rotary fibers and flame attenuated fibers are relatively short, with lengths on the order of 1 to 5 cm, and relatively fine, with diameters of 2 μm to 5 μm. Mats made from textile fibers tend to be stronger and less dusty than those made from rotary fibers or flame attenuated fibers, but are somewhat inferior in insulating properties. Mats made from rotary or flame attenuated fibers tend to have better thermal and acoustic insulation properties than those made from textile fibers, but are inferior in strength.

Conventional fiber insulation fails to provide a satisfactory combination of insulation and strength. Conventional fiber insulation also tends to be expensive. Especially in ductliner applications, a need exists for new, low cost, fiber products with improved thermal and acoustic insulation properties, as well as improved strength and handling characteristics.

### SUMMARY OF THE INVENTION

The present invention provides a fiber insulation product including a laminate of one or more layers of textile fibers and one or more layers of rotary and/or flame attenuated fibers. The fiber laminates of the present invention exhibit, for a specified mat density and thickness, mechanical strength higher than conventional rotary and/or flame attenuated fiber mats, and thermal and acoustic insulation properties higher than conventional textile fiber mats, but at a lower production cost than conventional textile fiber mats.

### BRIEF DESCRIPTION OF THE DRAWINGS

The preferred embodiments of the invention will be described in detail, with reference to the following figures, wherein

FIGS. 1A-1C show various laminates of rotary fiber mats and textile fiber mats on a scrim reinforcing layer.

FIGS. 2A-2B illustrate processes for manufacturing duct-liner including separate layers of rotary fibers and of textile fibers.

### DETAILED DESCRIPTION OF PREFERRED EMBODIMENTS

The fiber insulation product of the present invention can include one or more layers of textile fibers and one or more layers of rotary and/or flame attenuated fibers.

The fiber layers have a porous structure. The porous structure can be woven or nonwoven. Preferably, the porous structure is nonwoven. The nonwoven fibers can be in the form of a batt, mat or blanket. A preferred porous structure is that found in FIBERGLASS.

The fibers in the insulation product can be organic or inorganic. Suitable organic fibers include polymer fibers, such as rayon and polyester. Preferably, the fibers are inorganic. Inorganic fibers include rock wool and glass wool.

Preferably, the fibers are inorganic and comprise a glass. The glass can be, for example, an E-glass, a C-glass, or a high boron content C-glass.

In embodiments, each of the textile and rotary and/or flame attenuated fibers can be made of the same material. In other embodiments, the textile fibers can be made from one material, and the rotary and/or flame attenuated fibers can be made from a different material. In still other embodiments, different textile fibers can each be made from different materials; and different rotary or flame attenuated fibers can be made from different materials. Cost and insulation requirements will dictate the selection of the particular materials used in the textile, rotary and flame attenuated fibers. Preferably, the textile fibers are formed from starch coated or plastic coated E-glass and the rotary and flame attenuated fibers are formed from high boron C-glass.

Textile, rotary and flame attenuated fibers can be made in various ways known in the art. For example, textile fibers can be formed in continuous processes in which molten glass or polymer is extruded and drawn from apertures in lengths on the order of one mile. For use in insulation, the long textile fibers are divided into short segments by cutting techniques known in the art. Rotary fibers can be made or spun by using centrifugal force to extrude molten glass or polymer through small openings in the sidewall of a rotating spinner. Flame attenuated fibers can be formed by extruding molten glass or polymer from apertures and then blowing the extruded strands at right angles with a high velocity gas burner to remelt and reform the extruded material as small fibers.

The textile fibers used in the insulation product of the present invention have diameters of from greater than 5 μm to about 16 μm. Preferably the textile fibers are divided into segments with lengths of about 2 cm to about 15 cm, more preferably from about 6 cm to about 14 cm. The rotary and flame attenuated fibers have diameters of from about 2 μm to 5 μm and lengths of about 1 cm to about 5 cm.

Mats of fibers can be manufactured in various ways known in the art. For example, textile fibers can be collected to form a woven mat. Alternatively, after opening and cutting, textile fibers can be collected in a tangled mass on a stationary surface or on a moving conveyor or forming belt to form a non-woven batt, mat or blanket. Short rotary and flame attenuated fibers can be similarly collected and formed into a non-woven batt, mat or blanket.

A binder can be used to capture and hold the fibers together. The binder can be organic or inorganic. The binder can be a thermosetting polymer, a thermoplastic polymer, or a combination of both thermoplastic and thermosetting-polymers. Preferably, the thermosetting polymer is a phenolic resin, such as a phenol-formaldehyde resin, which will cure or set upon heating. The thermoplastic polymer will soften or flow upon heating above a temperature such as the melting point of the polymer. The heated binder will join and bond the fibers. Upon cooling and hardening, the binder will hold the fibers together. When binder is used in the insulation product, the amount of binder can be from 1 to 30 wt %, preferably from 3 to 25 wt %, more preferably from 4 to 24 wt %.

In embodiments of the present invention, an insulation product, e.g., ductliner, including at least one textile fiber layer and at least one rotary and/or flame attenuated fiber layer can be made by bonding together one or more pre-manufactured rotary and/or flame attenuated fiber mats and one or more pre-manufactured or on-line manufactured textile fiber mat. Preferably, the textile fiber layers and the rotary and/or flame attenuated fiber layers alternate in the laminate.

In embodiments, the bonding between two pre-manufactured fiber layers, or one pre-manufactured fiber layer and one on-line manufactured fiber layer, can be accomplished by applying a binder to the interface between the fiber layers, applying heat to cause the binder to flow and bond fibers to each other and in adjacent glass fiber layers, and then cooling the binder. Alternatively, the bonding can be accomplished by gluing the pre-manufactured layers together using a sprayed liquid adhesive.

In embodiments, a reinforcement layer including a scrim layer or non-woven mat can be used as base layer for the insulation product of the invention to provide additional mechanical support. An open netting bonded mesh scrim layer or a non-woven mat can be made of bonded glass fiber, or polyester, polypropylene, polyvinyl alcohol or polyvinyl chloride. The scrim or non-woven layer can be bonded to a pre-manufactured textile glass fiber layer or to a rotary and/or flame attenuated glass fiber layer with a binder. The layered product can also be formed on a common line in which the scrim or mat is applied and each textile fiber layer and rotary fiber layer is formed simultaneously, completing the layered product in a one step operation.

In embodiments, the thickness of the laminated insulation product of the present invention can be in a range from 10 to 80 mm, preferably from 20 to 60 mm, more preferably from 25 to 52 mm. The percentage of textile fiber in the product can be in a range of 1 to 99%, preferably from 30% to 70% and more preferably from 40% to 60%. The higher the percentage of textile fiber, the stronger the product. However, higher percentages of textile fiber lead to a reduction in acoustical and thermal insulation performance.

### EXAMPLES

The following non-limiting examples will further illustrate the invention.

### EXAMPLE 1

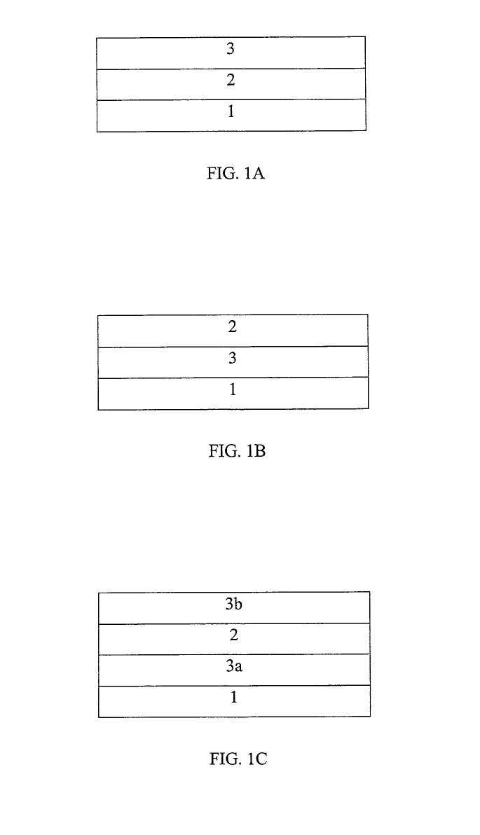

FIG. 1A shows an embodiment in which a rotary fiber layer 2 is laminated on a scrim or mat reinforcement layer 1, and a textile fiber layer 3 is laminated on the rotary fiber layer 2. FIG. 1B shows an embodiment in which a textile fiber layer 3 is laminated on a scrim or mat reinforcement layer 1, and a rotary fiber layer 2 is laminated on the textile fiber layer 3. FIG. 1C shows an embodiment in which a first textile fiber layer 3a is laminated on a scrim or mat reinforcement layer 1, a rotary fiber layer 2 is laminated on the first textile fiber layer 3a, and a second textile fiber layer 3b is laminated on the rotary fiber layer 2. Other embodiments in which a textile layer is sandwiched between two rotary or flame attenuated layers are also possible.

### EXAMPLE 2

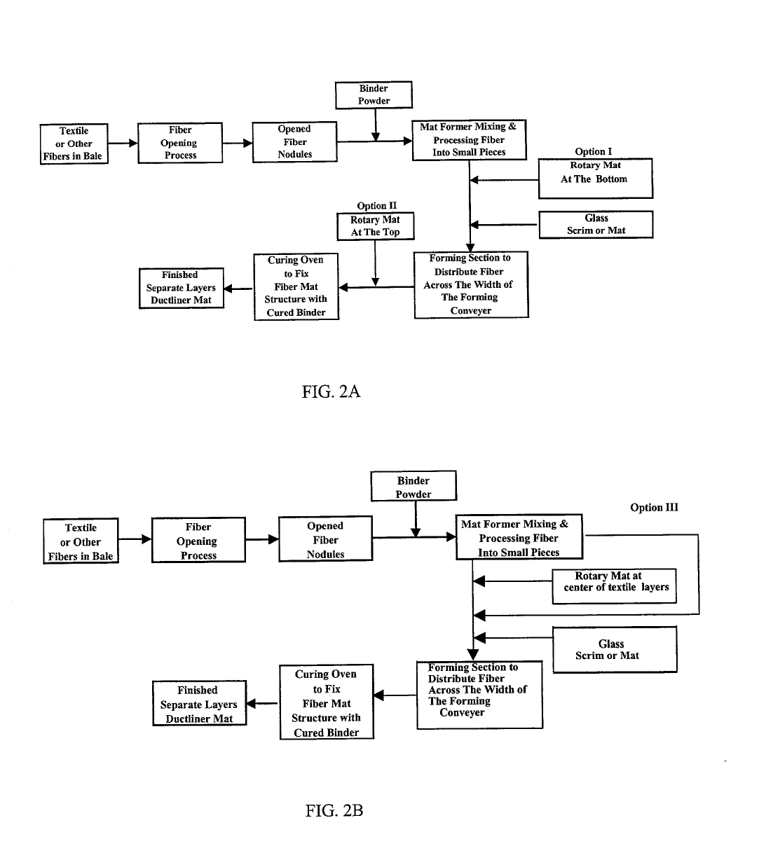

FIGS. 2A-2B illustrate three options according to the invention for forming an insulating product containing separate layers of rotary fibers and of textile fibers. First the textile or other fibers in a bale are opened. A powder binder is fed onto the surface of opened fibers. Both the binder and the fibers are mixed by passing through a tearing and mixing apparatus (called a “mat former”) where the textile fibers are cut into shorter lengths. In Option I, cut textile fibers and binder are distributed across the width of a forming conveyor belt on top of a rotary fiber mat laminated on a reinforcement layer of scrim or non-woven material. In Option II, cut textile fibers and binder are distributed across the width of the forming conveyor on top of a reinforcement layer of scrim or non-woven material, and a rotary fiber mat is laminated on top of the textile fibers. In Option III, cut textile fibers and binder are distributed across the width of a forming conveyor belt above and below a rotary fiber mat, and the textile/rotary/textile layered combination is laminated on a reinforcement layer of scrim or non-woven material. The laminates of Options I, II and III of reinforcement layer, rotary fiber layer and textile fiber layer(s) are then cured in an oven to fix the fibers with cured binder and form the finished multilayer ductliner insulation product.

Table I compares R-values (index of thermal insulation) and NRC-values (noise reduction coefficient) for a layer made of only textile fibers and a layer made of only rotary or flame attenuated fibers with estimated values for a bilayer containing two sublayers of equal thickness of rotary fibers and of textile fibers. The textile fibers are made from E-glass and the rotary or flame attenuated fibers are made from C-glass.

TABLE I

| Duct-liner Product: | | |
|---|---|---|
| 1.5 pounds per cubic foot, 2.54 cm thick | R-value | NRC |
| Layer of Textile Fibers only | 3.6 | 0.60 |
| Layer of Rotary or Flame Attenuated Fibers only | 4.2 | 0.70 |
| Bilayer of separate layers: Rotary (50%) - Textile (50%) | 4.0 | 0.65 |
| Fibers (estimated data) | | |

Table I shows that a bilayer with separate layers of equal thickness of rotary and of textile fibers has thermal and acoustic insulation properties close to those of a layer with only rotary or flame attenuated fibers. However, by including a separate layer of textile fibers, the bilayer will have improved strength relative to the layer of rotary or flame attenuated fibers only.

While the present invention has been described with respect to specific embodiments, it is not confined to the specific details set forth, but includes various changes and modifications that may suggest themselves to those skilled in the art, all falling within the scope of the invention as defined by the following claims.

What is claimed is:

1. An insulation product comprising
at least one layer containing first fibers each having a diameter of from 5 μm to about 2 μm; and
at least one layer containing second fibers each having a diameter of from greater than 5 μm to about 16 μm.

2. The product according to claim 1, wherein
the at least one layer containing second fibers comprises two layers containing the second fibers; and
one of the at least one layer containing first fibers is sandwiched between the two layers containing the second fibers.

3. The product according to claim 1, further comprising
a reinforcement layer comprising a scrim or non-woven material, wherein
one of the at least one layer containing first fibers is in direct contact with the reinforcement layer.

4. The product according to claim 1, further comprising
a reinforcement layer comprising a scrim or non-woven material, wherein
one of the at least one layer containing second fibers is in direct contact with the reinforcement layer.

5. The product according to claim 1, wherein the first fibers are about 1 cm to about 5 cm long.

6. The product according to claim 1, wherein the first fibers comprise a glass.

7. The product according to claim 6, wherein the glass is selected from the group consisting of an E-glass, a C-glass, and a boron doped C-glass.

8. The product according to claim 1, wherein the second fibers are about 2 cm to about 15 cm long.

9. The product according to claim 1, wherein the second fibers comprise a glass.

10. The product according to claim 9, wherein the glass is selected from the group consisting of an E-glass, a C-glass, and a boron doped C-glass.

11. The product according to claim 1, wherein each of the first fibers and the second fibers is an extruded fiber.

12. The product according to claim 1, wherein the at least one layer containing first fibers further comprises a binder.

13. The product according to claim 12, wherein the binder comprises a polymer.

14. The product according to claim 1, wherein the at least one layer containing second fibers further comprises a binder.

15. The product according to claim 14, wherein the binder comprises an organic polymer.

16. The product according to claim 1, further comprising a binder joining the at least one layer containing first fibers to the at least one layer containing second fibers.

17. The product according to claim 1, wherein
the at least one layer containing first fibers and the at least one layer containing second fibers are laminated on a means for reinforcing the insulation product.

18. The product according to claim 1, wherein
the at least one layer containing first fibers is non-woven, and
the at least one layer containing second fibers is non-woven.

19. A method of making an insulation product, the method comprising
laminating a first layer and a second layer, where the first layer contains first fibers each having a diameter of from 5 μm to about 2 μm and the second layer contains second fibers each having a diameter of from greater than 5 μm to about 16 μm; and
forming the insulation product of claim 1.

20. A method of making a insulation product, the method comprising
a step for laminating a first layer and a second layer, where the first layer contains first fibers each having a diameter of from 5 μm to about 2 μm and the second layer contains second fibers each having a diameter of from greater than 5 μm to about 16 μm; and
forming the insulation product of claim 1.
